(19) United States
(12) Patent Application Publication
(10) Pub. No.: US 2026/0112593 A1
(43) Pub. Date: Apr. 23, 2026

(54) THERMAL DESORPTION WITH UV IRRADIATION WITH SUBSEQUENT IONIZATION SYSTEMS AND METHODS

(71) Applicant: Teledyne FLIR Defense, Inc., Thousand Oaks, CA (US)

(72) Inventor: Brandon Reese, Thorntown, IN (US)

(21) Appl. No.: 19/354,008

(22) Filed: Oct. 9, 2025

Related U.S. Application Data
(60) Provisional application No. 63/709,884, filed on Oct. 21, 2024.

(51) Int. Cl. H01J 49/04; H01J 49/00

(52) U.S. Cl. CPC H01J 49/0463; H01J 49/0031; H01J 49/049

(57) ABSTRACT

A system and a method for thermal desorption using UV irradiation and subsequent ionization for sensing, monitoring, and identification of analytes are provided. In one or more embodiments, the system may include an ultraviolet light-emitting-diode (UV LED) source configured to emit radiation for desorbing analytes from a sample, an ionization source configured to ionize the desorbed analytes to produce ionized molecules at an atmospheric pressure, and a charged particle analyzer configured to analyze the ionized molecules to determine or identify a chemical composition or a chemical structure of the desorbed analytes. The method may include irradiating a sample comprising analytes via the UV LED source, ionizing the desorbed analytes to produce ionized molecules at an atmospheric pressure, and determining a chemical composition or a chemical structure of the desorbed analytes.

### CROSS REFERENCE TO RELATED APPLICATIONS

This application claims priority to and benefit of U.S. Provisional Patent Application No. 63/709,884 filed Oct. 21, 2024 and entitled “THERMAL DESORPTION WITH UV IRRADIATION WITH SUBSEQUENT IONIZATION SYSTEMS AND METHODS,” which is incorporated herein by reference in its entirety.

### GOVERNMENT SPONSORED RESEARCH

The present disclosure includes work commenced with the support from DTRA CWMD1916-004 on Base Agreement 2018-841. The government has certain rights in the invention.

### FIELD OF INVENTION

Embodiments of the present disclosure relate generally to desorption of materials from surfaces and, more particularly for example, to a method and a device for thermal desorption using UV irradiation and subsequent ionization.

### BACKGROUND

There are a wide variety of hazardous substances that require sensing, monitoring, and identification for various reasons, including national security. These substances include explosives, some traditional and non-traditional chemical warfare agents, and opioids such as fentanyl and nitazene, among many others. A particular challenge for the detection and identification of such chemicals is that many of them are very low volatility, such that they are not readily available in the vapor phase, but rather exist in a condensed phase as residues, for example, in the form of films, powders, droplets, etc., on suspected surfaces. In order to detect and identify such non-volatile or extremely-low-volatile materials using a highly sensitive instrument, such as a mass spectrometer (MS) or an ion mobility spectrometer (IMS), the residues must be first collected and then vaporized so that the vapor phase constituent molecules can be detected and identified. In such a workflow, the collection and vaporization steps in the sample preparation process typically hamper the entire process of detection and identification efforts. Thus, there is a need for a new system or method that can be used for desorption of such materials from surfaces directly, without manual collection and vaporization, so that the detection and identification steps can be streamlined in the workflow.

### SUMMARY

In accordance with one or more embodiments, a system for thermal desorption using UV irradiation and subsequent ionization for sensing, monitoring, and identification of analytes is provided. In one or more embodiments, the system includes an ultraviolet light-emitting-diode (UV LED) source configured to emit radiation for desorbing analytes from a sample; an ionization source configured to ionize the desorbed analytes to produce ionized molecules; and a charged particle analyzer configured to analyze the ionized molecules to determine or identify a chemical composition or a chemical structure of the desorbed analytes.

In one or more embodiments, the desorbed analytes comprise neutral molecules and the ionized molecules are produced at an atmospheric pressure or a reduced pressure ranging approximately between about 1 milliTorr and about 1 Torr. In one or more embodiments, the UV LED source is further configured to operate in a variable temperature control mode, which, during operation of the variable temperature control mode, enables selective desorption of the analytes based on a vapor pressure of analyte species present in the analytes. In one or more embodiments, the UV LED source is further configured to operate in a ramp rate control mode, which, during operation of the variable temperature control mode, enables selective desorption of the analytes based on a vapor pressure of analyte species present in the analytes. In one or more embodiments, the emitted radiation of the UV LED source matches an absorption band of the analytes being desorbed from the sample.

In one or more embodiments, the UV LED source is placed within 1-5 millimeters (or within 0.5-15 millimeters in some configurations) of the sample. In one or more embodiments, the ionization source employs atmospheric pressure chemical ionization (APCI), atmospheric pressure photoionization (APPI), secondary electrospray ionization (SESI), dielectric barrier discharge ionization (DBDI), or a combination thereof. In one or more embodiments, the ionization source may employ electron impact ionization (EII), photoelectric electron impact ionization (PEEI), chemical ionization (CI), photo ionization (PI), or a combination thereof.

In one or more embodiments, the charged particle analyzer includes a mass spectrometer or an ion mobility spectrometer. In one or more embodiments, the system may further include a pump configured to provide a supplementary flow to carry the ionized molecules to the charged particle analyzer. In one or more embodiments, the ionized molecules are transferred to the charged particle analyzer via a gas flow induced by a vacuum of the charged particle analyzer.

In accordance with one or more embodiments, a method for thermal desorption using UV irradiation and subsequent ionization for sensing, monitoring, and identification of analytes is provided. In one or more embodiments, the method includes irradiating, via an ultraviolet light-emitting-diode (UV LED) source, a sample comprising analytes; ionizing, via an ionization source, the desorbed analytes to produce ionized molecules; and determining, via a charged particle analyzer, a chemical composition or a chemical structure of the desorbed analytes.

In one or more embodiments, the UV LED source is configured to desorb the analytes from the sample via irradiation and wherein the desorbed analytes comprise neutral molecules, and wherein the ionized molecules are produced at an atmospheric pressure or a reduced pressure ranging approximately between about 1 milliTorr and about 1 Torr. In one or more embodiments, the UV LED source is further configured to operate in a variable temperature control mode, which, during operation of the variable temperature control mode, enables selective desorption of the analytes based on a vapor pressure of analyte species present in the analytes.

In one or more embodiments, the UV LED source is further configured to operate in a ramp rate control mode, which, during operation of the variable temperature control mode, enables selective desorption of the analytes based on a vapor pressure of analyte species present in the analytes. In one or more embodiments, the UV LED source is further configured to irradiate a radiation that matches an absorption band of the analytes being desorbed from the sample.

In one or more embodiments, the UV LED source is placed within 1-5 millimeters (or within 0.5-15 millimeters in some configurations) of the sample. In one or more embodiments, the ionization source employs atmospheric pressure chemical ionization (APCI), atmospheric pressure photoionization (APPI), secondary electrospray ionization (SESI), dielectric barrier discharge ionization (DBDI), or a combination thereof. In one or more embodiments, the ionization source may employ electron impact ionization (EII), photoelectric electron impact ionization (PEEI), chemical ionization (CI), photo ionization (PI), or a combination thereof. In one or more embodiments, the charged particle analyzer comprises a mass spectrometer or an ion mobility spectrometer.

In one or more embodiments, the method may further include providing a supplementary flow to carry the ionized molecules to the charged particle analyzer prior to the determining of the chemical composition or the chemical structure of the desorbed analytes. In one or more embodiments, the method may further include transferring the ionized molecules to the charged particle analyzer via a gas flow induced by a vacuum of the charged particle analyzer.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is a schematic illustration of thermal desorption of analytes from a sample using an ultraviolet (UV) source, in accordance with various embodiments.

FIGS. 2A, 2B, and 2C show various views of a computer-aided-design (CAD) model of a UV light-emitting-diode (LED) desorber atmospheric pressure ionization source, in accordance with various embodiments.

FIGS. 3A, 3B, 3C, and 3D show various views of a UV LED desorber atmospheric pressure ionization source, in accordance with various embodiments.

FIGS. 4A, 4B, and 4C show cross-sectional views of a UV LED desorber atmospheric pressure ionization source, in accordance with various embodiments.

FIG. 5 shows a time-resolved temperature profile from irradiation of a sample ticket with a UV LED source, in accordance with various embodiments.

FIGS. 6A, 6B, and 6C are plots showing ion-trap mass spectra of 10 ng fentanyl, 1 ng tributyl phosphate, and 10 ng cocaine, respectively, by UV desorption from samples via a UV LED source, in accordance with various embodiments.

FIG. 7 illustrates a flowchart for a method for determining of analytes, according to aspects of the present disclosure.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

In accordance with one or more embodiments herein, the disclosed methodologies include a system and method for desorption of hazardous materials and substances that require sensing, monitoring, and identification for various reasons, including national security. The disclosed system and method include desorption of such materials and substances directly from sample surfaces, without manual collection and vaporization. The disclosed system and method further include detection and identification of desorbed materials and substances in a streamlined workflow, in accordance with one or more embodiments.

In one or more embodiments, the disclosed system may employ an ultraviolet light-emitting-diode (UV LED) source that is configured to emit radiation that can be used to desorb analytes from a sample, such as a hazardous sample. The disclosed system may also include an ionization source that is configured to ionize the desorbed analytes from the sample to produce ionized molecules. This process using the disclosed system can be performed or occur at an atmospheric pressure (760 Torr) or at reduced pressures ranging approximately from about 1 milliTorr to about 1 Torr. Further, the disclosed system may include a charged particle analyzer that is configured to analyze the ionized molecules to determine or identify a chemical composition or a chemical structure of the desorbed analytes which were present in the sample. In other words, the disclosed system may be implemented for thermal desorption of a sample using UV irradiation and subsequent ionization for sensing, monitoring, and identification of analytes present in the sample.

Similarly, in one or more embodiments, the disclosed method may include irradiating via a UV LED source that is configured to emit radiation that can be used to desorb analytes from a sample, such as a hazardous sample. The disclosed method may also include ionizing via an ionization source that is configured to ionize the desorbed analytes from the sample to produce ionized molecules. This process step of the disclosed method can be performed or occur at an atmospheric pressure or at reduced pressures ranging approximately from about 1 milliTorr to about 1 Torr. Further, the disclosed method may include analyzing the ionized molecules using a charged particle analyzer that is configured to analyze, determine, and/or identify a chemical composition or a chemical structure of the desorbed analytes that were present in the sample. In other words, the disclosed method can be used in thermal desorption of a sample using UV irradiation and subsequent ionization for sensing, monitoring, and identification of analytes present in the sample.

As discussed herein, thermal desorption of substances by UV irradiation (followed by atmospheric pressure ionization or reduced pressure ionization) of porous or non-porous materials has many advantages over conventional thermal desorption with resistive heating elements. With UV irradiation, there is virtually zero start-up time for a UV desorption mechanism since an absorptive material can be heated to hundreds of degrees Celsius in a matter of seconds, whereas the start-up time (e.g., time to reach a specified temperature) for a conventional thermal desorber may be dependent on the power output of the heating elements, the thermal conductivity of the surrounding materials, and the thermal mass to be heated. Often, conventional thermal desorbers take minutes to achieve temperatures of >200 Celsius. Additionally, the average power consumption of a UV heating element is at least an order of magnitude lower than a resistive element since it does not need to be enabled continuously. Moreover, UV LEDs are small in form factors, and thus, a desorption chamber utilizing this technology may be easier to miniaturize (particularly without loss in performance) than a desorption chamber with resistive heaters, in accordance with the disclosed embodiments herein.

There are other advantages with the disclosed methodologies. For example, the ability to use a thermal desorber rather than liquid injection may simplify the use of an instrument. A low average power consumption thermal desorber that is at ambient temperature most of the time is valuable in the marketplace. This will allow for smaller batteries, without hot surfaces, and less time from “instrument on” to “instrument ready to provide results,” the UV desorber as disclosed herein may provide all of the advantages disclosed herein.

Moreover, the disclosed methodologies include a novel yet an efficient means of generating gas-phase neutral analytes from a sample on a porous or non-porous substrate via irradiation of the substrate via photons from a small LED light source emitting ultraviolet or near-ultraviolet (e.g. violet) rays. The emission band of the LED source is preferably matched with the absorption band of the substrate to maximize energy transfer to the substrate and thus cause an increase in surface temperature to cause thermal desorption of analytes. This ‘UV desorber’ is preferentially coupled with an atmospheric pressure ionization source (e.g. atmospheric pressure chemical ionization) or reduced pressure ionization to cause thermal desorption and ionization of analytes which can then be transferred into the vacuum chamber of a mass spectrometer for analysis.

In one embodiment, thermal desorption of sample molecules from swabs or tickets for subsequent ionization and analysis by a charged particle analyzer (mass spectrometer or ion mobility spectrometer) may be accomplished by placing resistive heating elements in direct contact with a thermally conductive (e.g. metal) desorption chamber. For example, a sample-containing ticket can be inserted into a region between two heated plates and sample neutrals can be transferred to the gas phase by clamping the plates together, causing thermal desorption of analytes from the ticket due to the rapid rise in temperature. Typically, the range of analytes that can be thermally desorbed is limited by their volatility (vapor pressure) and their boiling point (i.e. analytes with boiling points near or below the desorber temperature. The gas-phase neutral molecules can then be transported to an ionization region, either at atmospheric pressure or in vacuum, generated charged analyte particles that can then be analyzed by a mass spectrometer or ion mobility spectrometer. Although reliable in operation, desorbers with conventional resistive heating elements have long boot-up times (time to achieve a particular temperature) that increase with the thermal mass of the clamping elements, are safety hazards since the heating elements are generally always enabled while the desorber is operational, and consume a significant amount of power. Moreover, clamping desorbers have several mechanical elements that can pose a risk of failure and are difficult to miniaturize without reducing the desorption efficiency.

In accordance with one or more embodiments, the disclosed system may include a single high-power UV LED or an array of UV LEDs configured for thermal desorption from materials with absorption bands matching or near the emission wavelength(s) of the UV LED(s). By irradiating a sample ticket or swab with ultraviolet light from an LED source placed within proximity to the ticket, the temperature of the irradiated region can be increased rapidly within a matter of seconds, in one or more embodiments. Thermal desorption of substances by UV irradiation of porous or non-porous materials has many advantages over conventional thermal desorption with resistive heating elements. In one or more embodiment, there is an instantaneous, e.g., “virtually zero” start-up time, for a UV desorption mechanism since an absorptive material can be heated to hundreds of degrees Celsius in a matter of seconds. In one or more embodiments, an average power consumption of a UV heating element is at least an order of magnitude lower than a resistive element. In one or more embodiments, the UV heating element can operate on-demand, as opposed to be in a continuous mode, and thus can save energy usage. In one or more embodiments, small UV LEDs can be used with the disclosed system, and accordingly, the desorption chamber utilizing the small UV LEDs can be miniaturized, without a loss in performance, compared to a desorption chamber with resistive heaters or resistive heating elements.

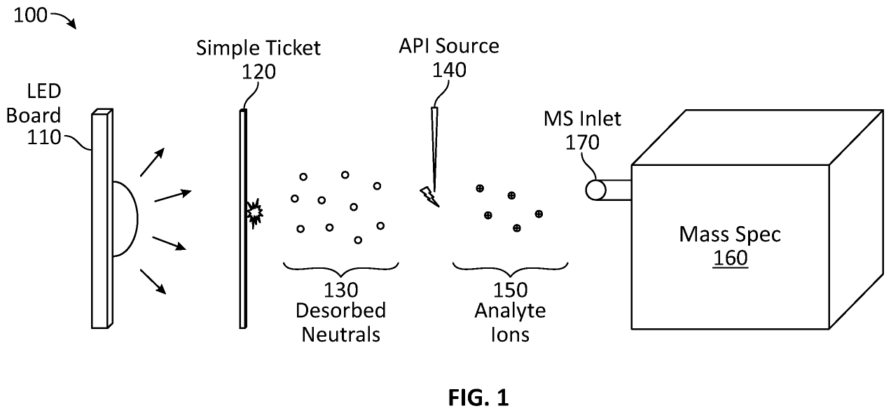

FIG. 1 is a schematic illustration 100 of thermal desorption of analytes from a sample using an ultraviolet (UV) source, in accordance with various embodiments. As illustrated in schematic illustration 100 of FIG. 1, a LED board (e.g., an array of UV LEDs) 110 can be used to irradiate a sample ticket 120 to desorb analytes (desorbed neutrals) 130, which can be ionized using an atmospheric pressure ionization (API) source 140 to obtain ionized molecules (analyte ions) 150. Although demonstrated with an API source 140 in FIG. 1, a reduced pressure source can be used instead for ionization of the desorbed analytes/neutrals 130 in one or more embodiments. In some embodiments, the irradiation at a wavelength close to the absorption band, such as around ultraviolet (UV) wavelengths, of the ticket. The ionized molecules/analyte ions 150 are then received by a mass spectrometer (MS) 160 via an MS inlet 160, as shown in FIG. 1. In some embodiments, the ionized molecules/analyte ions 150 can be transferred into a vacuum chamber of the MS 160, or another ion analyzer, such as, for example, but not limited to, an ion mobility spectrometer.

In one or more embodiments, the sample ticket 120 can include, for example, Nomex, which absorbs its maximum energy around 360 nm (near UV), resulting in an increase in ticket temperature. This wavelength is a common wavelength of about 365 nm for compact UV LEDs. By placing the LED board/UV LED 110 in close proximity to the sample ticket 120, for example, within a few millimeters, and irradiating it for some predetermined period of time (e.g., seconds), the temperature of the sample ticket 120 can be increased to greater than 300° C., causing thermal desorption of analytes from the sample ticket 120. In one or more embodiments, the sample ticket 120 can be irradiated on the front of the sample ticket 120 or on the rear of the sample ticket 120. In one or more embodiments, either position or placement of the sample ticket 120 can cause desorption of analytes previously deposited on the sample ticket 120. The desorbed amount may depend based on the irradiation time, the distance between the LED board/UV LED 110 and the sample ticket 120, and a power output of the LED board/UV LED 110 are sufficient. In some instances, thermal desorption may create gas-phase neutral molecules 130 which can then be ionized via an (API) source 140, as shown in FIG. 1. In some embodiments, the API source 140 may include atmospheric pressure chemical ionization (APCI), atmospheric pressure photoionization (APPI), secondary electrospray ionization (SESI), and dielectric barrier discharge ionization (DBDI), among others. In one or more embodiments, the API source 140 can include electron impact ionization (EII), photoelectric electron impact ionization (PEEI), chemical ionization (CI), photo ionization (PI), among many others. As further illustrated in FIG. 1, the analyte ions 150 generated at atmospheric pressure by the API source 140 can be transferred into a vacuum chamber of a charged particle analyzer, such as the MS 160 or ion mobility spectrometer (not shown) for analysis.

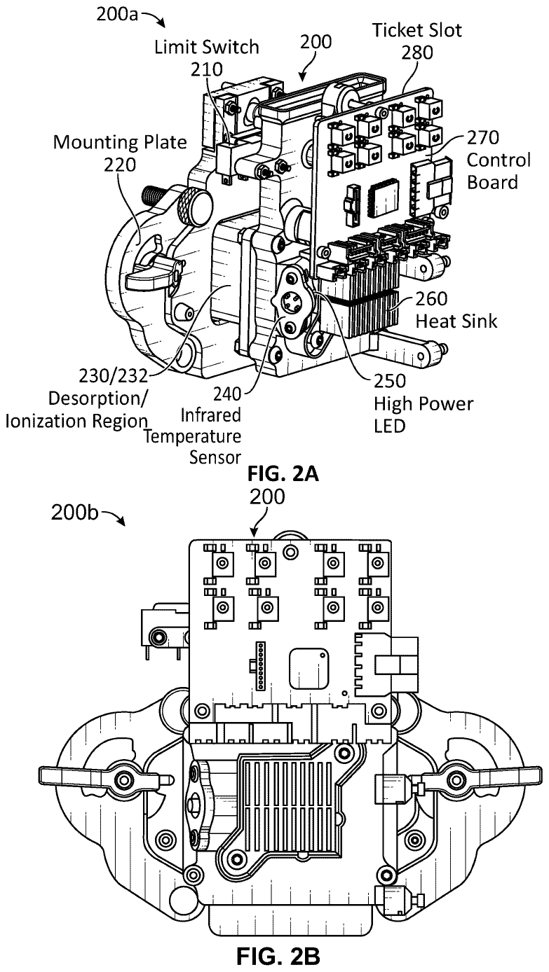

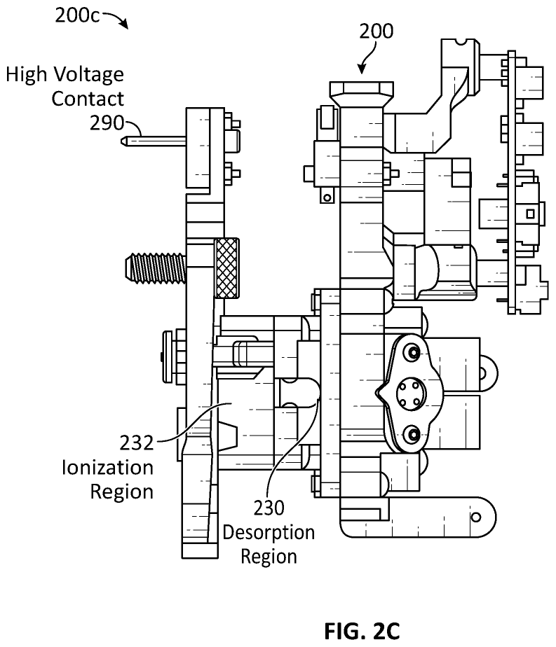

FIGS. 2A, 2B, and 2C show various views of a computer-aided-design (CAD) model of a UV LED desorber API source 200, in accordance with various embodiments. Specifically, FIG. 2A shows a 3-dimensional (3D) isometric view 200a, FIG. 2B shows a view 200b from rear, and FIG. 2C shows a view 200c from a side of the UV LED desorber API source 200. As shown in FIGS. 2A, 2B, and 2C, the UV LED desorber API source 200 includes a light switch 210, a mounting plate 220, a desorption region/ionization region 230/232, an infrared sensor 240, a high-power LED 250, a heatsink 260, a control board 270, a sample ticket slot 280 and a high voltage contact 290.

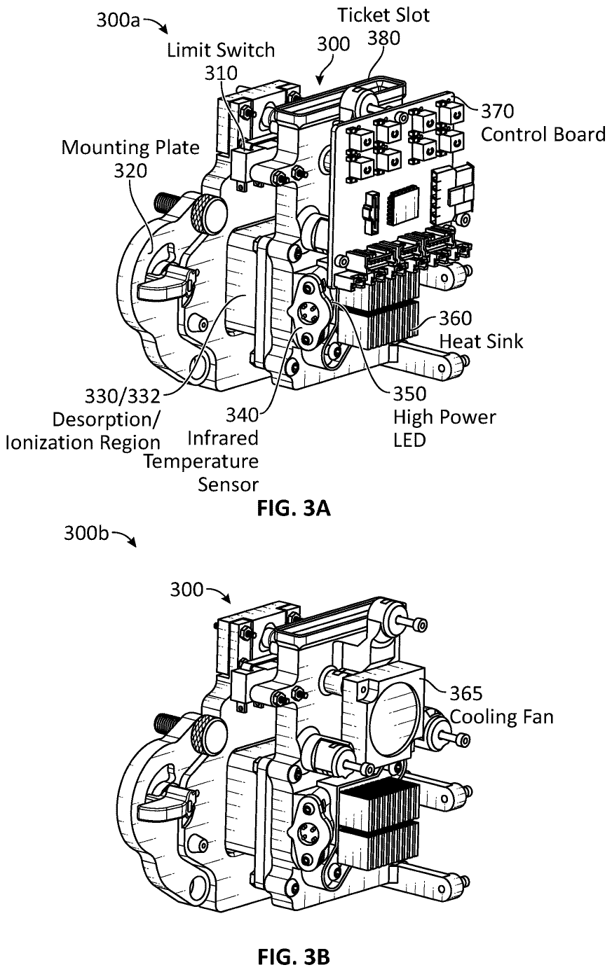

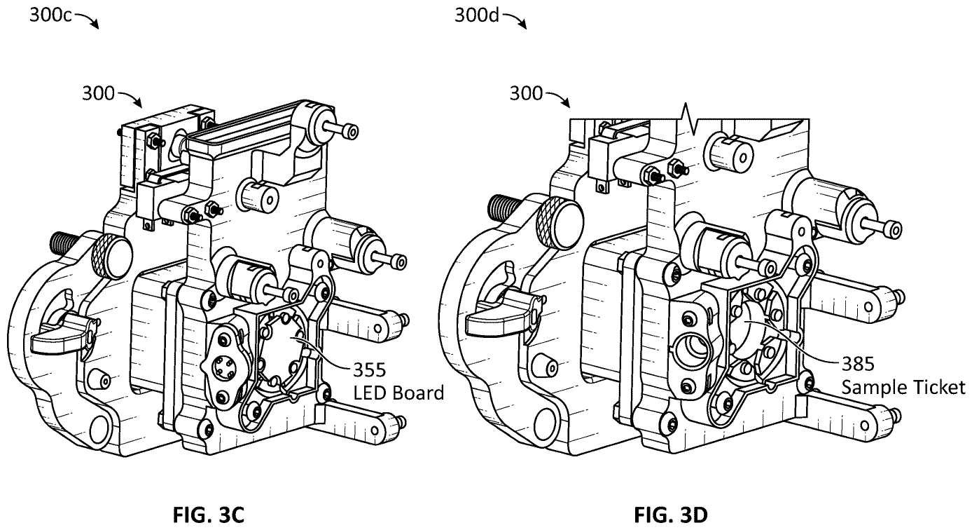

FIGS. 3A, 3B, 3C, and 3D show various views of a UV LED desorber API source 300, in accordance with various embodiments. Specifically, FIG. 3A shows a 3D isometric view 300a of all components, FIG. 3B shows a view 300b with a control board 370 removed, FIG. 3C shows a view 300c with the control board 370, a LED heat sink 360, and a LED cooling fan 365 removed, and FIG. 3D shows a view 300d with the control board 370, the LED heat sink 360, the LED cooling fan 365, and a LED board 355 removed. As shown in FIGS. 3A, 3B, 3C, and 3D, the UV LED desorber API source 300 includes a light switch 310, a mounting plate 320, a desorption region/ionization region 330/332, an infrared temperature sensor 340, a high-power LED 350, the heatsink 360, the control board 370, a sample ticket slot 380, and a sample ticket 385.

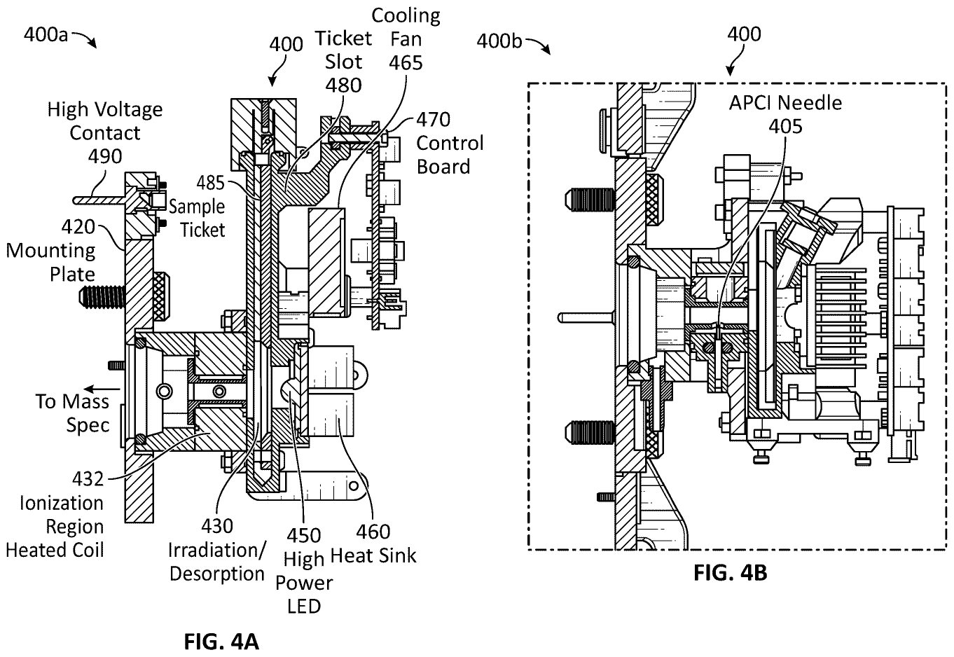

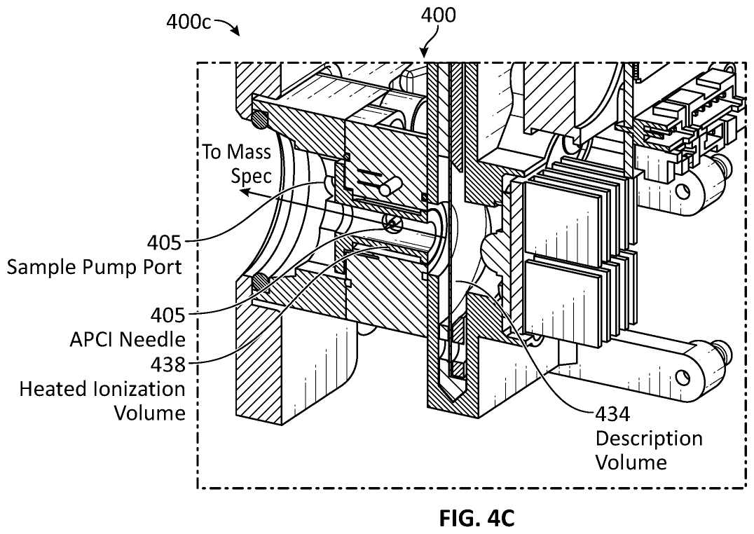

FIGS. 4A, 4B, and 4C show cross-sectional views of a UV LED desorber API source 400, in accordance with various embodiments. Specifically, FIG. 4A shows a view 400a showing a desorption region 430/volume 434 (e.g., sample ticket 485 irradiation) and a main ionization region with heated coil 432/volume 438, FIG. 4B shows a view 400b of the ionization volume 438 showing a high voltage needle 405 for atmospheric pressure chemical ionization (APCI), also referred to herein as APCI needle 405, after sample desorption from the sample ticket 485, and FIG. 4C shows a view 400c view of the desorption and ionization regions 430/432 with arrow indicating direction of sample travel. High voltage wire connecting the high voltage contact with the APCI needle is not shown. As shown in FIGS. 4A, 4B, and 4C, the UV LED desorber API source 400 includes a mounting plate 420, a desorption region/ionization region 430/432, a high-power LED 450, the heatsink 460, a cooling fan 465 the control board 470, a sample ticket slot 480, the sample ticket 485, and a high voltage contact 490.

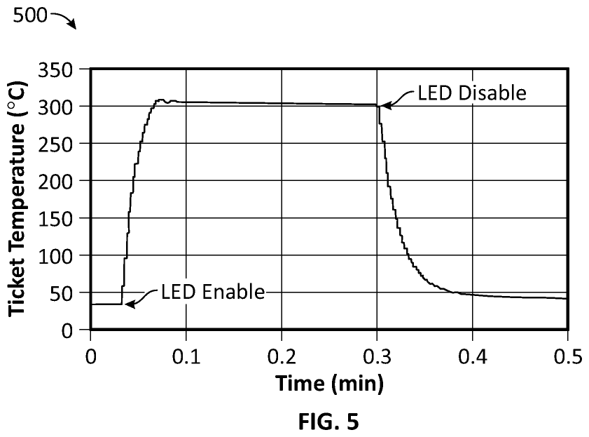

FIGS. 2A, 2B, 2C, 3A, 3B, 3C, 3D, 4A, 4B, and 4C show example UV LED desorber API sources 200, 300, and 400, respectively. In one or more embodiments, the UV LED desorber API sources 200, 300, and 400 may include a high-power 395 nm UV/violet LED with ˜6 W luminous flux placed in-line with a sample ticket slot. The sample tickets may include Nomex, which absorbs radiation most strongly around 360 nm. By irradiating the ‘front’ or ‘rear’ of the sample ticket for several seconds with the LED, the temperature of the ticket can be increased to 300° C. in a matter of seconds with insignificant power usage compared to resistive heating, as shown in FIG. 5. Specifically, FIG. 5 shows a time-resolved temperature profile 500 from irradiation of a sample ticket with a UV LED source, in accordance with various embodiments. The time-resolved temperature profile 500 shown in FIG. 5 includes irradiation of a Nomex ticket with a ˜395 nm UV LED placed in the configuration as shown in FIGS. 2A, 2B, 2C, 3A, 3B, 3C, 3D, 4A, 4B, and 4C where a difference in LED enable and LED disable can illustrate a rapid change in temperatures.

As shown in FIGS. 2A, 2B, 2C, 3A, 3B, 3C, 3D, 4A, 4B, and 4C, the temperature of the sample ticket may be measured with an infrared sensor, such as sensor 240 or 340. The rate of temperature increase, and the final temperature of the ticket can be controlled by throttling the power usage of the LED, in one or more embodiments. The rapid increase in ticket temperature causes thermal desorption of analytes from the ticket so long as the boiling point of the analyte is near or below the final ticket temperature, creating gas-phase analyte neutrals that can be transported downstream in the device for further processing.

The gas-phase neutral analytes are then ionized by an atmospheric pressure ionization source, in this case via a corona discharge created by application of a high voltage to a sharp needle, causing atmospheric pressure chemical ionization, as shown in FIGS. 4A, 4B, and 4C. The sample neutrals and ions can be directed along the length of the device (i.e. through the desorption region and then the ionization region) by supplementary flow provided by, for example, a sample pump, or by the flow induced by the vacuum of an ion analyzer (e.g. mass spectrometer or ion mobility spectrometer). The ionization region is preferably heated to prevent carryover and contamination and also to prevent condensation of analytes on the walls of the ionization volume. Once the ions/neutrals reach the end of the ionization region, they can be transported into the vacuum system of a mass spectrometer for analysis.

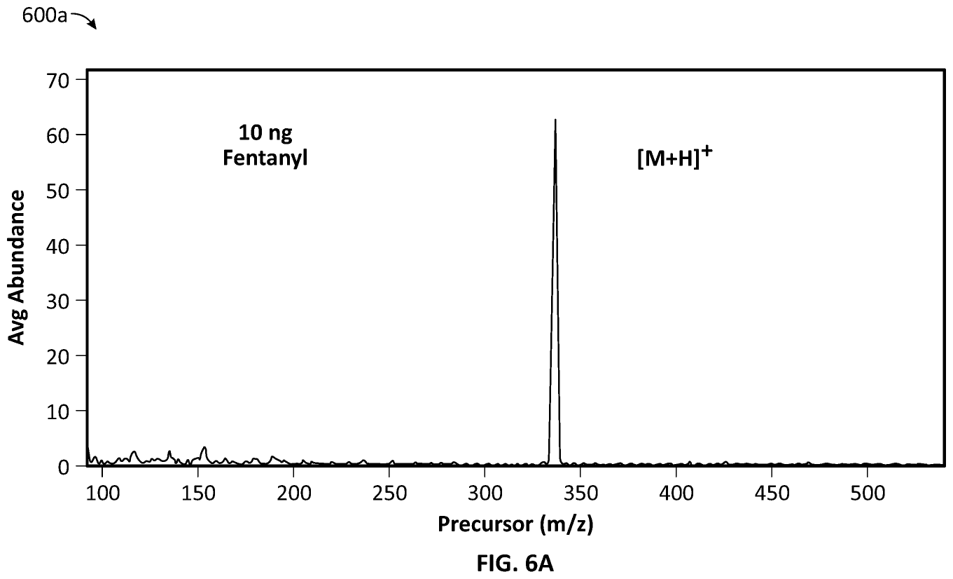

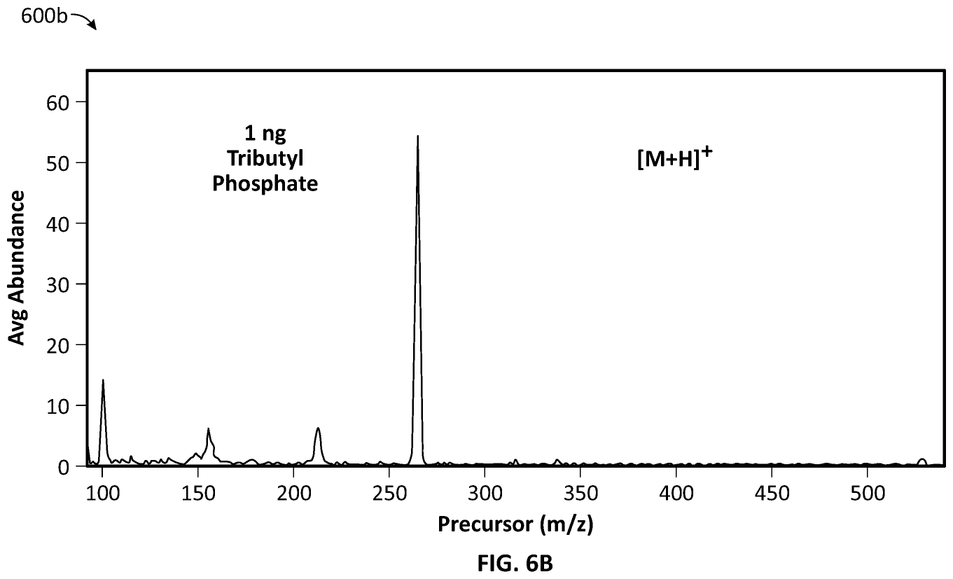

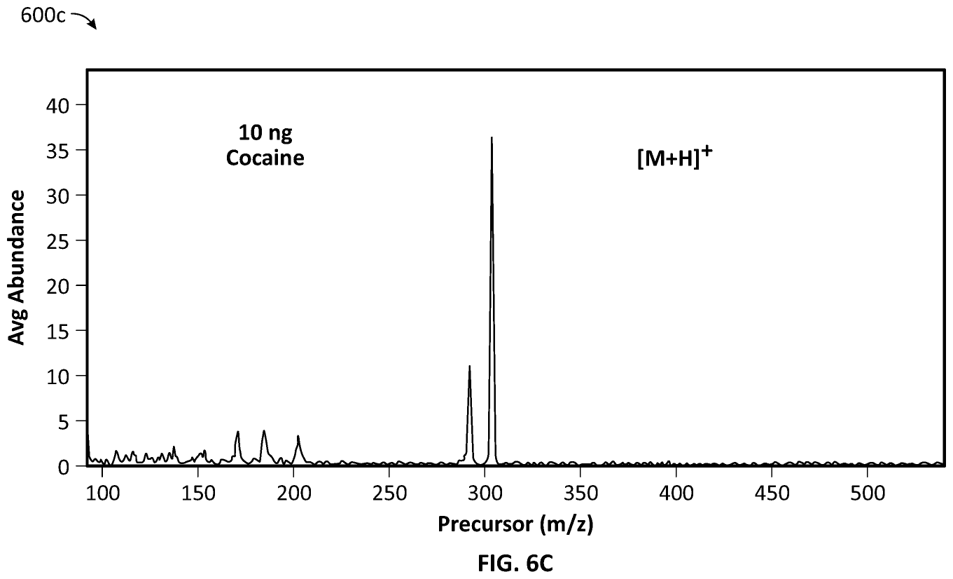

FIGS. 6A, 6B, and 6C are plots showing ion-trap mass spectra of 10 ng fentanyl, 1 ng tributyl phosphate, and 10 ng cocaine, respectively, by UV desorption from samples via a UV LED source, in accordance with various embodiments. Specifically, FIG. 6A depicts a plot 600a showing ion trap mass spectra of 10 ng fentanyl, FIG. 6B depicts a plot 600b showing ion trap mass spectra of 1 ng tributyl phosphate, and FIG. 6C depicts a plot 600c showing ion trap mass spectra of 10 ng cocaine by UV desorption from Nomex tickets via a ˜395 nm UV/violet LED (6 W luminous flux) followed by atmospheric pressure chemical ionization. The mass spectra 600a, 600b, and 600c shown in FIGS. 6A, 6B, and 6C are collected on a compact linear ion trap mass spectrometer utilizing the UV desorption chamber described in FIGS. 2A, 2B, 2C, 3A, 3B, 3C, 3D, 4A, 4B, and 4C. Solutions containing 1-10 ng of material were deposited on Nomex tickets and allowed to evaporate to dryness. The tickets are then irradiated for ˜5 s with a 395 nm UV/violet LED with 6 W luminous flux to cause thermal desorption of the analytes followed by atmospheric pressure chemical ionization. Subsequently the ions were transferred into the vacuum chamber of the mass spectrometer and mass analyzed, giving the spectra shown.

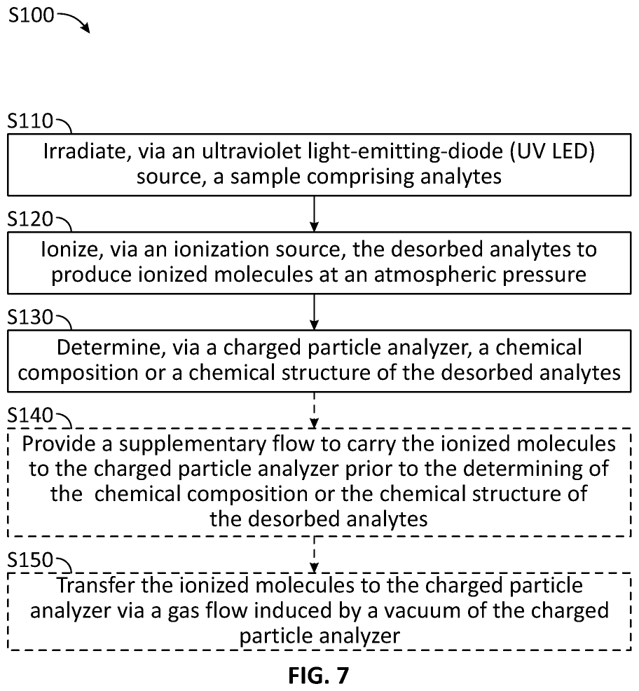

FIG. 7 illustrates a flowchart for a method S100 for determining of analytes, according to aspects of the present disclosure. In one or more embodiments, the method S100 may be deployed for desorption of hazardous materials and substances that require sensing, monitoring, and identification for various reasons, including national security. The disclosed method S100 may include desorption of such materials and substances directly from sample surfaces, without manual collection and vaporization. The disclosed method S100 may further include detection and identification of desorbed materials and substances in a streamlined workflow, in accordance with one or more embodiments.

In one or more embodiments, the method S100 for determining of analytes may include at step S110, irradiating, via an ultraviolet light-emitting-diode (UV LED) source, a sample comprising analytes; at step S120, ionizing, via an ionization source, the desorbed analytes to produce ionized molecules at an atmospheric pressure (or at reduced pressures ranging approximately from about 1 milliTorr to about 1 Torr); and at step S130, determining, via a charged particle analyzer, a chemical composition or a chemical structure of the desorbed analytes.

In one or more embodiments, the UV LED source is further configured to desorb the analytes from the sample via irradiation and wherein the desorbed analytes comprise neutral molecules. In one or more embodiments, the UV LED source is further configured to operate in a variable temperature control mode, which, during operation of the variable temperature control mode, enables selective desorption of the analytes based on a vapor pressure of analyte species present in the analytes.

In one or more embodiments, the UV LED source is further configured to operate in a ramp rate control mode, which, during operation of the variable temperature control mode, enables selective desorption of the analytes based on a vapor pressure of analyte species present in the analytes. In one or more embodiments, the UV LED source is further configured to irradiate a radiation that matches an absorption band of the analytes being desorbed from the sample.

In one or more embodiments, the UV LED source is placed within 1-5 millimeters (or within 0.5-15 millimeters in some configurations) of the sample. In one or more embodiments, the ionization source employs atmospheric pressure chemical ionization (APCI), atmospheric pressure photoionization (APPI), secondary electrospray ionization (SESI), dielectric barrier discharge ionization (DBDI), or a combination thereof. In one or more embodiments, the ionization source may employ electron impact ionization (EII), photoelectric electron impact ionization (PEEI), chemical ionization (CI), photo ionization (PI), or a combination thereof. In one or more embodiments, the charged particle analyzer comprises a mass spectrometer or an ion mobility spectrometer.

In one or more embodiments, the method S100 may optionally include, at step S140, providing a supplementary flow to carry the ionized molecules to the charged particle analyzer prior to the determining of the chemical composition or the chemical structure of the desorbed analytes.

In one or more embodiments, the method S100 may optionally include, at step S150, transferring the ionized molecules to the charged particle analyzer via a gas flow induced by a vacuum of the charged particle analyzer.

What is claimed is:

1. A system, comprising:
an ultraviolet light-emitting-diode (UV LED) source configured to emit radiation for desorbing analytes from a sample;
an ionization source configured to ionize the desorbed analytes to produce ionized molecules; and
a charged particle analyzer configured to analyze the ionized molecules to determine or identify a chemical composition or a chemical structure of the desorbed analytes.

2. The system of claim 1, wherein the desorbed analytes comprise neutral molecules and the ionized molecules are produced at an atmospheric pressure or a reduced pressure ranging approximately between about 1 milliTorr and about 1 Torr.

3. The system of claim 1, wherein the UV LED source is further configured to operate in a variable temperature control mode, which, during operation of the variable temperature control mode, enables selective desorption of the analytes based on a vapor pressure of analyte species present in the analytes.

4. The system of claim 1, wherein the UV LED source is further configured to operate in a ramp rate control mode, which, during operation of the variable temperature control mode, enables selective desorption of the analytes based on a vapor pressure of analyte species present in the analytes.

5. The system of claim 1, wherein the emitted radiation of the UV LED source matches an absorption band of the analytes being desorbed from the sample.

6. The system of claim 1, wherein the UV LED source is placed within 1-5 millimeters of the sample.

7. The system of claim 1, wherein the ionization source employs atmospheric pressure chemical ionization (APCI), atmospheric pressure photoionization (APPI), secondary electrospray ionization (SESI), dielectric barrier discharge ionization (DBDI), or a combination thereof.

8. The system of claim 1, wherein the charged particle analyzer comprises a mass spectrometer or an ion mobility spectrometer.

9. The system of claim 1, further comprising:
a pump configured to provide a supplementary flow to carry the ionized molecules to the charged particle analyzer.

10. The system of claim 1, wherein the ionized molecules are transferred to the charged particle analyzer via a gas flow induced by a vacuum of the charged particle analyzer.

11. A method, comprising:
irradiating, via an ultraviolet light-emitting-diode (UV LED) source, a sample comprising analytes;
ionizing, via an ionization source, the desorbed analytes to produce ionized molecules; and
determining, via a charged particle analyzer, a chemical composition or a chemical structure of the desorbed analytes.

12. The method of claim 11, wherein the UV LED source configured to desorb the analytes from the sample via irradiation and wherein the desorbed analytes comprise neutral molecules, and wherein the ionized molecules are produced at an atmospheric pressure or a reduced pressure ranging approximately between about 1 milliTorr and about 1 Torr.

13. The method of claim 11, wherein the UV LED source is further configured to operate in a variable temperature control mode, which, during operation of the variable temperature control mode, enables selective desorption of the analytes based on a vapor pressure of analyte species present in the analytes.

14. The method of claim 11, wherein the UV LED source is further configured to operate in a ramp rate control mode, which, during operation of the variable temperature control mode, enables selective desorption of the analytes based on a vapor pressure of analyte species present in the analytes.

15. The method of method 11, wherein the UV LED source is further configured to irradiate a radiation that matches an absorption band of the analytes being desorbed from the sample.

16. The method of claim 11, wherein the UV LED source is placed within 1-5 millimeters of the sample.

17. The method of claim 1, wherein the ionization source employs atmospheric pressure chemical ionization (APCI), atmospheric pressure photoionization (APPI), secondary electrospray ionization (SESI), dielectric barrier discharge ionization (DBDI), or a combination thereof.

18. The method of claim 11, wherein the charged particle analyzer comprises a mass spectrometer or an ion mobility spectrometer.

19. The method of claim 11, further comprising:
providing a supplementary flow to carry the ionized molecules to the charged particle analyzer prior to the determining of the chemical composition or the chemical structure of the desorbed analytes.

20. The method of claim 11, further comprising:
transferring the ionized molecules to the charged particle analyzer via a gas flow induced by a vacuum of the charged particle analyzer.
